(19) United States
(12) Patent Application Publication
(10) Pub. No.: US 2013/0327269 A1
(43) Pub. Date: Dec. 12, 2013

(54) VARIABLE DISCHARGE WIDTH DEVICE AND APPLYING DEVICE

(71) Applicant: Nobuhisa Suhara, Shiga (JP)

(72) Inventor: Nobuhisa Suhara, Shiga (JP)

(73) Assignee: HEISHIN Ltd., Kobe-shi (JP)

(21) Appl. No.: 13/991,883

(22) PCT Filed: Dec. 5, 2011
(86) PCT No.: PCT/JP2011/078113

§ 371 Date: Aug. 23, 2013

(30) Foreign Application Priority Data
Dec. 6, 2010 (JP) 2010-271250

(51) Int. Cl. B05B 1/30

(52) U.S. Cl. CPC B05B 1/30
USPC 118/323; 239/451

(57) ABSTRACT

A variable discharge width device includes a hollow outer cylindrical part where inside and outside thereof communicate with each other via a discharge port, and an inner cylindrical part rotatable inside the outer cylindrical part along a circumferential wall of the outer cylindrical part. The inner cylindrical part can introduce fluid thereinto, and has a circumferential part opening formed in the circumferential wall so that inside and outside of the inner cylindrical part communicate with each other. The circumferential part opening is formed so that an opening width thereof changes in the circumferential direction of the inner cylindrical part. The variable discharge width device is capable of discharging the fluid introduced into the inner cylindrical part, from a communicating area formed by intersecting the circumferential part opening and the discharge port.

This application is a national phase application under 35 U.S.C. §371 of International Application Serial No. PCT/JP2011/078113 filed on Dec. 5, 2011, and claims priority under 35 U.S.C. §119 to Japanese Patent Application No. JP2010-271250, filed on Dec. 6, 2010, which are hereby expressly incorporated by reference in their entirety for all purposes.

### TECHNICAL FIELD

The present invention relates to a variable discharge width device which is capable of change a discharge width for applying liquid, and also relates to an applying device provided with the variable discharge width device.

### BACKGROUND OF THE INVENTION

Conventionally, for example, a slit coating method disclosed in the Japanese Patent Application Publication No. JP2004-358311A (hereinafter Patent Literature 1), an applying device disclosed in the Patent Application Publication No. JP05-007809A (hereinafter Patent Literature 2), and a variable applying width device disclosed in the Patent Application Publication No. JP11-179260A (hereinafter Patent Literature 3), which are described below, have been provided. The slit coating method of Patent Literature 1 described below uniformly applies applying liquid to an application area, while synchronizing a feeding amount of the applying liquid required for forming a film thickness of a liquid coating film being applied, a discharge port width, and a relative speed of an application head with respect to a substrate. The application head used for the slit coating method can expand and contract or change the dimension of a slit width by relatively moving in a slit width direction a rear lip member and a front lip member which are symmetrically arranged.

Moreover, the applying device disclosed in Patent Literature 2 described below includes an applying means for applying an applying agent while contacting a base material which is an object to be applied, and a variable means for changing an applying width for the applying agent to the base material by adjusting the contacting area between the applying means and the base material.

The variable applying width device disclosed in Patent Literature 3 described below varies an applying width through which applying liquid is applied to a web which is an object to be applied, by using spacers which are inserted in both end portions of a slit of an application head, and pocket valves inserted in both end portions of a manifold. The variable applying width device constitutes the spacer with two plate bodies, an upper spacer and a lower spacer, and has a configuration in which the applying width can be adjusted by sliding at least the upper spacer.

However, the application head, the applying device, and the variable applying width device disclosed in the conventional technologies described above are all structured to change the capacity of a part where fluid to be applied (applying liquid) is reserved, with a change in the discharge width. Therefore, in the conventional technologies, even if the discharge liquid is supplied from the outside to the application head or the like in the same conditions, there is a problem that a discharge pressure may vary when discharged toward the object to be applied. If the discharge pressure of the applying liquid is unstable, there arises another problem that the applying liquid cannot be applied in constant quality.

Thus, the purpose of the present invention is to provide a variable discharge width device in which, even if a discharge width is changed, a variation in a discharge pressure is hardly caused, and to provide an applying device provided with the variable discharge width device.

### SUMMARY OF THE INVENTION

A variable discharge width device of the present invention provided to resolve the problem described above includes a discharge port forming part where a discharge port is formed, and includes a hollow outer cylindrical part where inside and outside communicate with each other via the discharge port, and a hollow inner cylindrical part rotatable inside the outer cylindrical part along a circumferential wall of the outer cylindrical part. A circumferential part opening is formed in a circumferential wall of the inner cylindrical part so that inside and outside of the inner cylindrical part communicate with each other, and the circumferential part opening is formed so that an opening width thereof in an axial direction and/or an opening position thereof in the axial direction change in the circumferential direction of the inner cylindrical part. Fluid can be introduced into the inner cylindrical part. The variable discharge width device of the present invention is capable of discharging the fluid introduced into the inner cylindrical part, from a communicating area formed by intersecting the circumferential part opening and the discharge port.

The variable discharge width device of the present invention can discharge the fluid from the communicating area formed by intersecting the circumferential part opening formed in the circumferential wall of the inner cylindrical part and the discharge port formed in the discharge port forming part of the outer cylindrical part. Further, in the variable discharge width device of the present invention, since the opening width and/or the position of the circumferential part opening change in the circumferential direction of the inner cylindrical part, a width of the communicating area and/or a position of the communicating area can be adjusted by rotating the inner cylindrical part. Thus, according to the variable discharge width device of the present invention, only by rotating the inner cylindrical part to adjust the width and/or the position of the communicating area, it is possible to adjust the discharge width to a desired size, and/or, to adjust the position at which the fluid is discharged to a desired position. Therefore, problems, such as a reduction in operating efficiency due to the change in the discharge width and/or the discharge position, can be resolved.

Since the variable discharge width device of the present invention is to change the discharge width or the like by rotating the inner cylindrical part, the change in the internal capacity associated with the change in the discharge width or the like similar to the conventional technologies is hardly caused. Thus, a variation in the discharge pressure when discharging the fluid from the variable discharge width device can be suppressed to the minimum.

The variable discharge width device of the present invention is desirable to be sealed in a liquid-tight manner at a position on one end side and the other end side of the inner cylindrical part with respect to the circumferential part opening, between an outer circumferential wall of the inner cylindrical part and an inner circumferential wall of the outer cylindrical part.

According to this configuration, the fluid is bitten between the inner cylindrical part and the outer cylindrical part, and this can prevent that the fluid is leaked from an unexpected location of the discharge port.

The variable discharge width device of the present invention is desirable to have an introduction port for introducing the fluid fed from the outside formed in the circumferential wall of the outer cylindrical part at a position where it faces the circumferential part opening.

According to this configuration, the fluid introduced from the introduction port can be substantially directly introduced into the inner cylindrical part. Thus, it can prevent that the fluid fed from the outside is bitted between the inner cylindrical part and the outer cylindrical part.

In the variable discharge width device of the present invention, it is desirable in that an opening width of the discharge port is greater than the opening width of the circumferential part opening in the axial direction.

According to this configuration, the fluid can certainly be prevented from entering between the inner cylindrical part and the outer cylindrical part.

The variable discharge width device of the present invention is desirable to include a control device capable of adjusting a rotating amount of the inner cylindrical part with respect to the outer cylindrical part according to the discharge width of the fluid.

According to this configuration, it is possible to easily and correctly adjust the rotating amount of the inner cylindrical part so that it becomes in an optimal state to make the discharge width of the fluid to be a desired width.

Further, an applying device of the present invention provided to resolve the problem described above includes a fluid feeding device for feeding fluid from the outside, and a variable discharge width device for discharging the fluid fed by the fluid feeding device with a predetermined discharge width. In the applying device of the present invention, the fluid feeding device is comprised of a uniaxial eccentric screw pump. Further, the variable discharge width device has a discharge port forming part where a discharge port is formed, and has an hollow outer cylindrical part where inside and outside thereof communicates via the discharge port, and an inner cylindrical part rotatable inside the outer cylindrical part along a circumferential wall of the outer cylindrical part. The fluid can be introduced into the inner cylindrical part. A circumferential part opening is formed in the circumferential wall of the inner cylindrical part so that inside and outside of the inner cylindrical part communicate with each other, and the circumferential part opening is formed so that an opening width thereof in an axial direction and/or an opening position thereof in the axial direction change in the circumferential direction of the inner cylindrical part. The fluid introduced into the inner cylindrical part can be discharged from a communicating area formed by intersecting the circumferential part opening and the discharge port.

The variable discharge width device adopted to the applying device of the present invention adjusts, by rotating the inner cylindrical part, a width and/or a position of the communicating area formed by intersecting the circumferential part opening formed in the circumferential wall of the inner cylindrical part and the discharge port formed in the discharge port forming part of the outer cylindrical part. Thus, it is possible to adjust the discharge width of the fluid to a desired size, and/or to adjust the position where the fluid is discharged to a desired position. Therefore, the applying device of the present invention can easily adjust the discharge width and/or the discharge position of the fluid with sufficient accuracy, and can prevent, for example, a reduction in operating efficiency associated with the change in the discharge width.

In the applying device of the present invention, since the uniaxial eccentric screw pump is adopted as the fluid feeding device, the fluid can be fed to the variable discharge width device at substantially constant feeding amount and feeding pressure. Further, since the variable discharge width device of the present invention is to change the discharge width or the like by rotating the inner cylindrical part, the change in internal capacity associated with the change in the discharge width or the like similar to the conventional technologies is hardly caused. Thus, the applying device of the present invention can suppress the variation in the discharge pressure and the discharging amount of the fluid to the minimum.

The applying device of the present invention is preferred to include a control device implementable in a state where a discharge width control in which the discharge width of the fluid is controlled by adjusting the rotating amount of the inner cylindrical part with respect to the outer cylindrical part, and a feeding amount control in which the feeding amount of the fluid to the variable discharge width device is controlled by controlling operation of the uniaxial eccentric screw pump are synchronized.

According to this configuration, it is possible to optimize a balance of the discharge width and the discharging amount of the fluid discharged as an object for application.

The applying device of the present invention is preferred to include a moving device capable of changing a relative position between the object to be applied and the fluid feeding device, and to include a control device implementable in a state where a discharge width control in which the discharge width of the fluid is controlled by adjusting the rotating amount of the inner cylindrical part to the outer cylindrical part, and a position control in which the relative position of the fluid feeding device with respect to the object to be applied is controlled by a motion control of the moving device are synchronized.

According to this configuration, it is possible to adjust the discharge width and the discharge position of the fluid discharged as the object for application so that they become in a suitable state according to a spatial relationship between the object to be applied and the variable discharge width device. Thus, other than applying the fluid with different widths according to a location of the object to be applied, it is possible to apply the fluid in various modes, such as drawing a pattern of a desired pattern on the object to be applied.

According to the present invention, it can provide a variable discharge width device in which, even if the discharge width and/or the discharge position are changed, a variation in the discharge pressure is hardly caused, and it can also provide an applying device provided with such a variable discharge width device.

### BRIEF DESCRIPTION OF THE DRAWINGS

The present disclosure is described in conjunction with the appended figures:

FIG. 1 is a conceptual diagram illustrating an applying device according to one embodiment of the present invention.

FIG. 2 is a cross-sectional view showing a pump and a variable discharge width device which are adopted to the applying device shown in FIG. 1.

FIG. 3 is a perspective view showing a state where the variable discharge width device is partially cut out.

FIG. 4(a) is a cross-sectional view of the variable discharge width device shown in FIG. 3, and FIG. 4(b) is a bottom view.

FIG. 5 is a diagram illustrating a relation between a circumferential wall of an inner cylindrical part and a discharge port formed in an outer cylindrical part, in the variable discharge width device shown in FIG. 3.

FIG. 6 is a block diagram showing a configuration of a control device.

FIG. 7 is a flowchart showing a flow of applying operation by the applying device shown in FIG. 1.

FIGS. 8(a) to (d) are pattern diagrams respectively showing examples of an application pattern by the applying device shown in FIG. 1.

FIGS. 9(a) to (l) are pattern diagrams respectively showing examples of the application pattern by the applying device shown in FIG. 1.

FIGS. 10(a) to (g) are pattern diagrams respectively showing examples of the application pattern which are possible by changing the shape of a circumferential part opening formed in the inner cylindrical part.

FIG. 11 is a diagram illustrating a relation between a circumferential wall of an inner cylindrical part and a discharge port formed in an outer cylindrical part, in a variable discharge width device according to a modified embodiment.

### DETAILED DESCRIPTION OF THE INVENTION

Embodiments of the present invention will be described hereinafter with reference to the accompanying drawings, in which preferred exemplary embodiments of the invention are shown. The ensuing description is not intended to limit the scope, applicability or configuration of the disclosure. Rather, the ensuing description of the preferred exemplary embodiments will provide those skilled in the art with an enabling description for implementing preferred exemplary embodiments of the disclosure. It should be noted that this invention may be embodied in different forms without departing from the spirit and scope of the invention as set forth in the appended claims

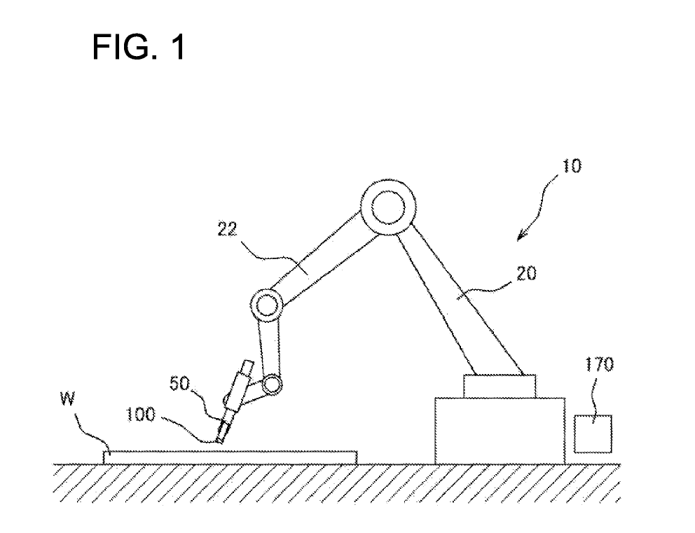

An applying device 10 and a variable discharge width device 100 according to one embodiment of the present invention are described in detail, with reference to the drawings. As shown in FIG. 1, the applying device 10 includes an industrial robot 20 (moving device), a uniaxial eccentric screw pump 50 (hereinafter, also simply referred to as “the pump 50”), the variable discharge width device 100, and a control device 170. The industrial robot 20 is comprised of a robot arm. The pump 50 is attached at the tip end of an arm 22 of the industrial robot 20, and the pump 50 can be moved with respect to an application object W, which is an object to be applied with applying liquid (fluid), by operating the industrial robot 20.

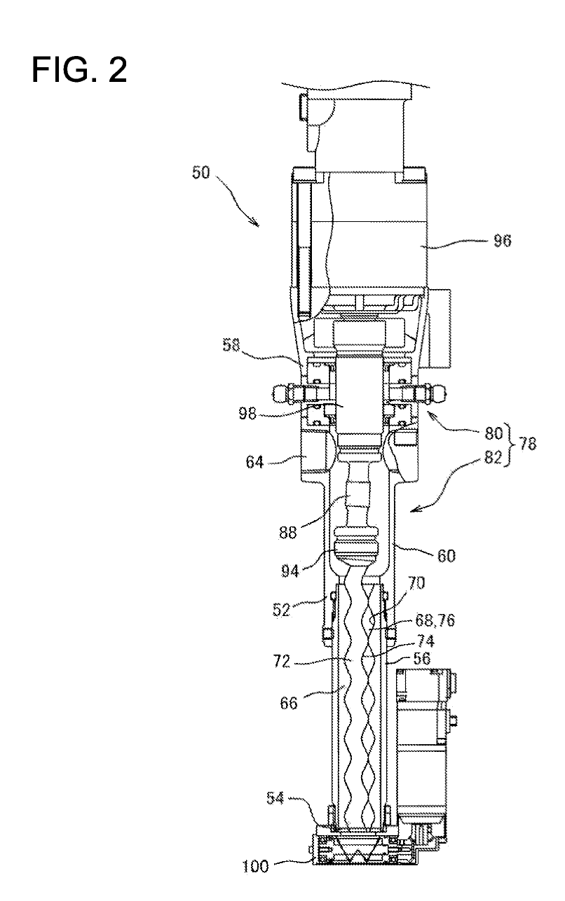

The pump 50 is a device (a fluid feeding device) provided to pump the applying liquid from the outside. The pump 50 is so-called a rotary displacement pump, and, as shown in FIG. 2, it is configured so that a stator 66, a rotor 72, a power transmission mechanism 78 and the like are accommodated inside a casing 52. The casing 52 is a cylindrical member made of metal, where a first opening 54 is formed on one end side in a longitudinal direction. The variable discharge width device 100, which will be described later in detail, is attached to the end portion at which the first opening 54 is formed. A second opening 64 is formed in an outer circumferential portion of the casing 52. The second opening 64 communicates with an interior space of the casing 52, through a middle part 60 located in the middle portion of the casing 52 in the longitudinal direction.

The first opening 54 and the second opening 64 are portions which function as a suction port and a discharge port of the pump 50, respectively. The pump 50 can pump fluid by rotating the rotor 72 in a positive direction so that the first opening 54 functions as the discharge port and the second opening 64 functions as the suction port. Alternatively, it is possible to pump the fluid by rotating the rotor 72 in the opposite direction so that the first opening 54 functions as the suction port and the second opening 64 functions as the discharge port. In this embodiment, the rotor 72 operates so that the first opening 54 functions as the discharge port and the second opening 64 functions as the suction port.

The stator 66 is a member having the appeared shape of a substantially cylinder, which is formed of elastic bodies such as rubber, or resin. The stator 66 is accommodated in a stator attaching part 56 at a position of the casing 52 adjacent to the first opening 54. An outer diameter of the stator 66 is substantially the same as an inner diameter of the stator attaching part 56. Thus, the stator 66 is attached in a state where an outer circumferential wall substantially and closely contacts with the inner circumferential wall of the stator attaching part 56. One end side of the stator 66 is pinched by the variable discharge width device 100, which will be described later in detail, in one end portion of the casing 52.

An inner circumferential wall 70 of the stator 66 is formed in a single-twist or multiple-twist female thread shape with n-grooves. In this embodiment, the stator 66 is formed in a multiple-twist female thread shape with two grooves. Specifically, a penetrating bore 68, which extends along the longitudinal direction of the stator 66 and is twisted in the pitch described above, is formed inside the stator 66. The penetrating bore 68 is formed such that, even if it is seen in a cross section at any position of the stator 66 in the longitudinal direction, the cross-sectional shape (aperture shape) becomes substantially an ellipse.

The rotor 72 is a metal shaft body and is formed in a single-twist or multiple-twist female thread shape with n-1 grooves. In this embodiment, the rotor 72 is formed in an eccentric male thread shape with one groove. The rotor 72 is formed so that, even if it is seen in a cross section at any position in the longitudinal direction, the cross-sectional shape becomes substantially a true circle. The rotor 72 is inserted into the penetrating bore 68 formed in the stator 66 described above, and it is freely and eccentrically rotatable inside the penetrating bore 68.

When the rotor 72 is inserted into the stator 66, an outer circumferential wall 74 of the rotor 72 and an inner circumferential wall 70 of the stator 66 become in a state where they closely contact with each other at their tangent lines, and a fluid conveying path 76 is formed between the inner circumferential wall 70 of the stator 66 and the outer circumferential wall of the rotor 72. The fluid conveying path 76 spirally extends in the longitudinal direction of the stator 66 and the rotor 72.

When the rotor 72 is rotated inside the penetrating bore 68 of the stator 66, the fluid conveying path 76 advances in the longitudinal direction of the stator 66, while it revolve inside the stator 66. Thus, when the rotor 72 is rotated, it is possible to suck fluid into the fluid conveying path 76 from one end side of the stator 66, transfer the fluid toward the other end side of the stator 66 in a state where the fluid is sealed inside the fluid conveying path 76, and discharge the fluid at the other end side of the stator 66. By rotating the rotor 72 in the positive direction, the pump 50 of this embodiment is possible to pump the fluid sucked from the second opening 64, and discharge the fluid from the first opening 54 toward the variable discharge width device 100, which will be described in detail later.

The power transmission mechanism 78 is to transmit power from a pump drive 96 provided outside the casing 52 to the rotor 72 described above. The power transmission mechanism 78 has a power transmission unit 80 and an eccentric rotation unit 82. The power transmission unit 80 is provided to the casing 52 on one end side in the longitudinal direction.

The eccentric rotation unit 82 is provided in the middle part 60 formed between the power transmission unit 80 and the stator attaching part 56. The eccentric rotation unit 82 is a part which connects the power transmission unit 80 and the rotor 72 so that they are able to transmit power therebetween. The eccentric rotation unit 82 has a coupling shaft 88 comprised of a conventionally known coupling rod and a screw rod, and coupling bodies 94 and 98 comprised of a conventionally known universal joint. Thus, the eccentric rotation unit 82 can transmit the rotational power generated by operating the pump drive 96 to the rotor 72, and eccentrically rotate the rotor 72.

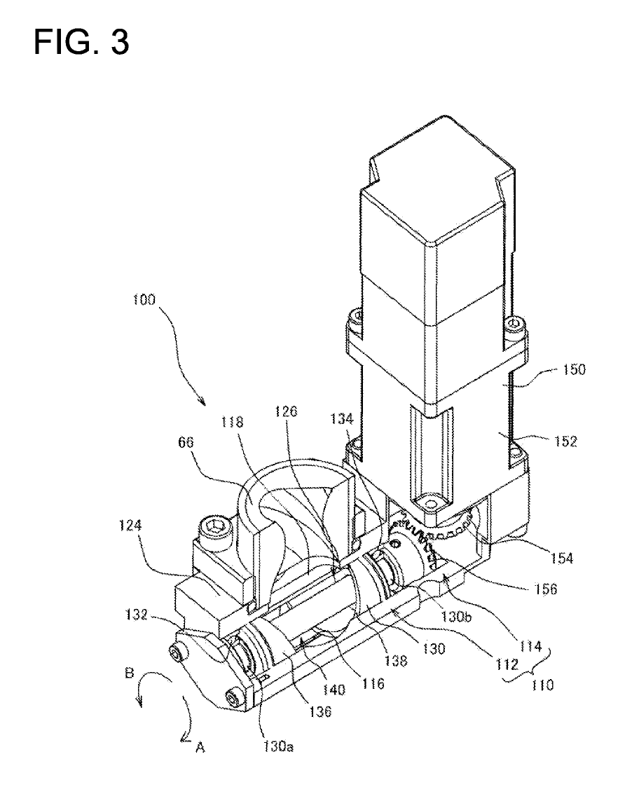

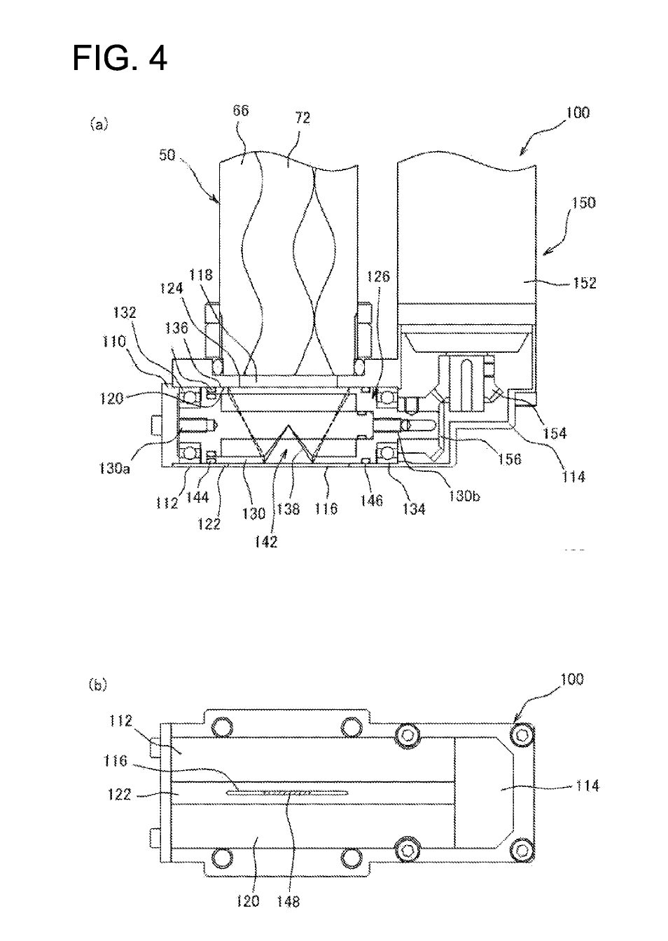

The variable discharge width device 100 can discharge the applying liquid pumped by the pump 50 through a predetermined discharge width. As shown in FIG. 2, the variable discharge width device 100 is connected with the end portion of the pump 50 on the first opening 54 side described above. As shown in FIGS. 3 and 4, the variable discharge width device 100 includes a casing 110, an inner cylindrical part 130, and a drive mechanism unit 150 (driving device).

The casing 110 has a hollow and cylindrical outer cylindrical part 112, and a drive mechanism installation part 114. The outer cylindrical part 112 is a cylindrical part having the inner cylindrical part 130 therein, and includes a discharge port 116 and an introduction port 118. The drive mechanism installation part 114 is a part where components constituting the drive mechanism unit 150, as will be described later in detail, are accommodated.

The discharge port 116 formed in the outer cylindrical part 112 is formed in a discharge port forming part 122 which constitutes a part of a circumferential wall 120 of an outer cylindrical part 112. The discharge port 116 is comprised of an opening which is of a slit shape and extends linearly, and communicates the inside and outside of the outer cylindrical part 112 therethrough. The introduction port 118 is to connect with the first opening 54 of the pump 50 described above, and is formed in the introduction port forming part 124 provided in the circumferential wall 120 of the outer cylindrical part 112. The introduction port 118 faces toward (adapts to) a circumferential part opening 138 formed in the inner cylindrical part 130 described later in detail.

The inner cylindrical part 130 is accommodated in an outer cylinder interior space 126 formed inside the outer cylindrical part 112, and it is a hollow cylinder having an outer diameter which is substantially the same size as the inner diameter of the inner cylindrical part 130. The inner cylindrical part 130 is rotatably supported by bearings 132 and 134 on one end side (a base end 130a side) and the other end side (a connecting end 130b side) thereof, respectively. The inner cylindrical part 130 projects to the drive mechanism installation part 114 side on which the connecting end 130b is formed on one end side of the casing 110, and it is connected with the drive mechanism unit 150.

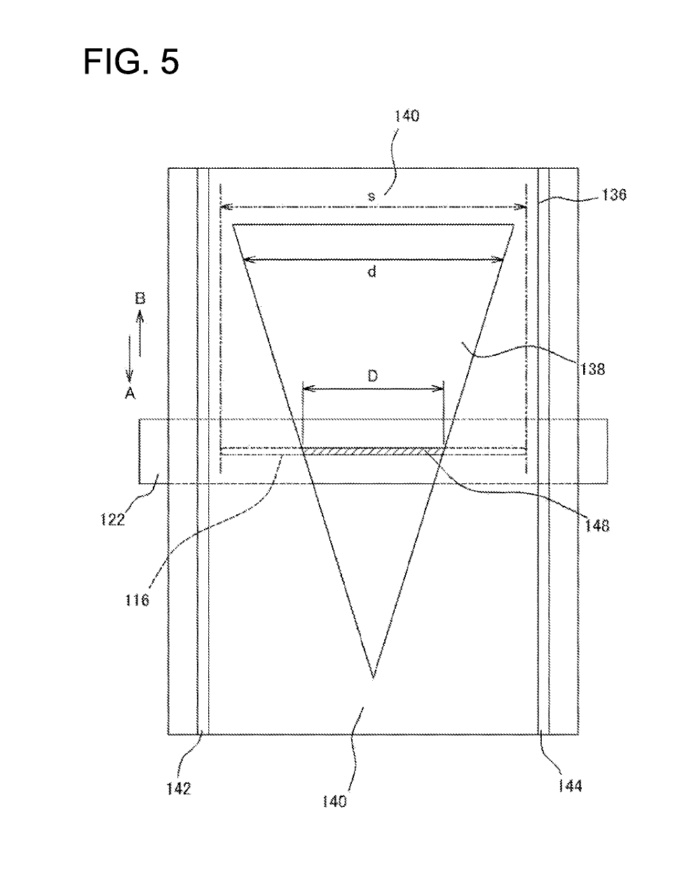

The circumferential part opening 138 is formed in the circumferential wall 136 of the inner cylindrical part 130 so that the inside and outside of the inner cylindrical part 130 communicate with each other therethrough. The circumferential part opening 138 is formed at a position to oppose (face) to the introduction port 118 formed in the outer cylindrical part 112, and, applying liquid pumped by the pump 50 can be introduced therethrough into the inner cylinder interior space 142 inside the inner cylindrical part 130. As shown in FIG. 5, the circumferential part opening 138 is formed so that an opening width d (a length of the inner cylindrical part 130 in a generating line direction) continuously varies in the circumferential direction of the inner cylindrical part 130. Specifically, the circumferential part opening 138 has an opening shape of a substantially isosceles triangle in a state where the inner cylindrical part 130 is developed. Further, a non-opening portion 140 is formed at a position deviated from the circumferential part opening 138 in the circumferential direction of the inner cylindrical part 130. As shown in FIG. 5, the opening width d of the circumferential part opening 138 is smaller at any position than an opening width s of the discharge port 116 formed in the outer cylindrical part 112.

As shown in FIGS. 3, 4, and 5, O-rings 144 and 146 are provided all around the periphery of the inner cylindrical part 130 at a position on the base end 130a side and a position on the connecting end 130b side with respect to the circumferential part opening 138, respectively. The O-rings 144 and 146 is to seal in a liquid-tight manner between the circumferential wall 136 of the inner cylindrical part 130 and the circumferential wall 120 of the outer cylindrical part 112. Thus, the applying liquid introduced into the inner cylinder interior space 142 of the inner cylindrical part 130 will not be leaked to areas beyond at least the positions at which the O-rings 144 and 146 are provided, on the base end 130a side and the connecting end 130b side of the inner cylindrical part 130, respectively.

As shown in FIGS. 3 and 4, the drive mechanism unit 150 has a drive 152 comprised of a motor, a first bevel gear 154 connected with a rotation shaft of the drive 152, and a second bevel gear 156 connected with the connecting end 130b side of the inner cylindrical part 130. The drive 152 is installed so that the rotation shaft projects into the drive mechanism installation part 114 of the casing 110. The first bevel gear 154 and the second bevel gear 156 are accommodated in the drive mechanism installation part 114, and both gears are meshed together. Thus, the inner cylindrical part 130 can be rotated inside the outer cylindrical part 112 by operating the drive 152. Further, by controlling a rotating amount and a rotating direction of the drive 152, an adjustment of the rotating amount and a change in the rotating direction of the inner cylindrical part 130 can be carried out.

As shown by hatching in FIG. 5, a communicating area 148 is formed in an intersecting portion of the variable discharge width device 100 between the discharge port 116 formed in the outer cylindrical part 112 and the circumferential part opening 138 formed in the inner cylindrical part 130, through which both the discharge port 116 and the circumferential part opening 138 communicate with each other. Further, by adjusting the rotating amount and the rotating direction of the drive 152, and by changing the relative position of the discharge port 116 and the circumferential part opening 138, a width D of the communicating area 148 (hereinafter, also referred to as “the discharge width D”) can be varied. In this embodiment, when the inner cylindrical part 130 is rotated in an arrow A direction in FIGS. 3 and 5, the discharge width D of the communicating area 148 gradually increases, and when rotated in an arrow B direction, which is opposite from the arrow A direction, the discharge width D gradually decreases. Further, when the inner cylindrical part 130 is rotated to a position where the non-opening portion 140 intersects with the discharge port 116, it will be in a state where the discharge port 116 is blocked by the non-opening portion 140, i.e., a state where the discharge width D becomes zero and the applying liquid cannot be discharged.

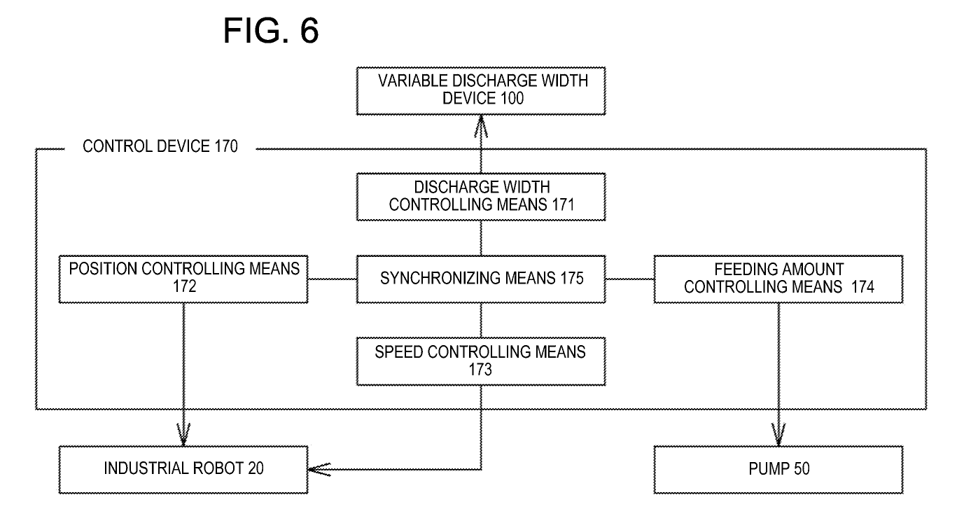

The control device 170 is able to perform independently or combinedly a position control in which a relative position of the pump 50 is controlled with respect to the application object W, a speed control in which a moving speed of the pump 50 is controlled with respect to the application object W, a feeding amount control in which a feeding amount of the applying liquid to the variable discharge width device 100 is controlled, a discharge width control in which the discharge width of the applying liquid discharged from the variable discharge width device 100 is controlled, etc. Specifically, as shown in FIG. 6, the control device 170 includes a discharge width controlling means 171, a position controlling means 172, a speed controlling means 173, a feeding amount controlling means 174, and a synchronizing means 175.

The control device 170 can control the position of the pump 50 attached to the tip end of the arm 22 by the position controlling means 172 adjusting a position of the industrial robot 20, an angle and a stretching amount of the arm 22, etc. (position control). The control device 170 can control the moving speed of the pump 50 with respect to the application object W by adjusting the moving speeds of the industrial robot 20 and the arm 22 by speed controlling means 173 (speed control).

Further, the control device 170 can control the feeding amount of the applying liquid to the variable discharge width device 100 by controlling the revolving speed of the pump drive 96 by the feeding amount controlling means 174 (feeding amount control). Further, the control device 170 adjusts the rotating amount and the rotating direction of the drive 152 of the variable discharge width device 100 by the discharge width controlling means 171, and changes a relative position of the discharge port 116 provided in the outer cylindrical part 112 and the circumferential part opening 138 provided in the inner cylindrical part 130 to increase and decrease the discharge width D. Thus, the control device 170 can control the discharge width of the applying liquid by performing the motion control of the drive 152 (discharge width control).

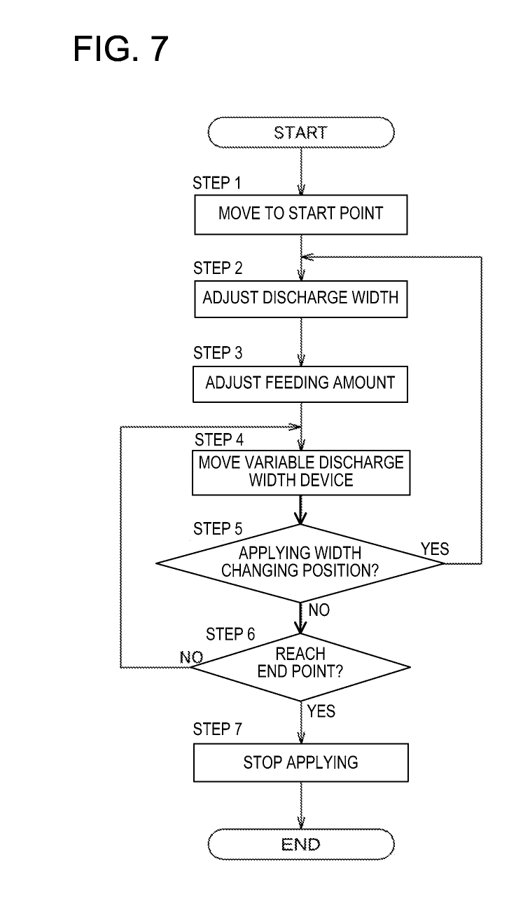

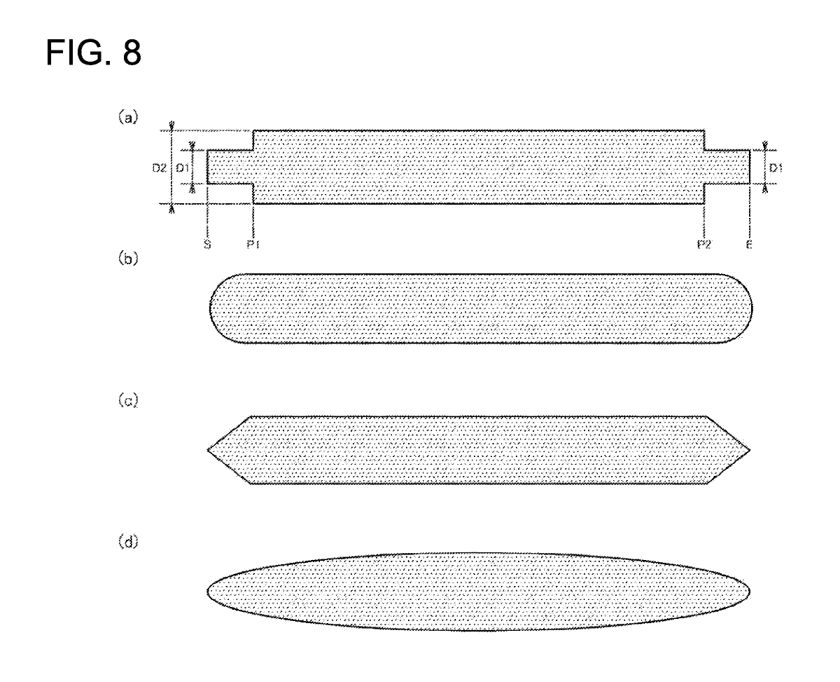

The control device 170 can respectively synchronize the position control, the speed control, the feeding amount control, and the discharge width control described above by the synchronizing means 175. Accordingly, it is possible to apply the applying liquid at a desired position of the application object W with a desired applying width, to apply the applying liquid at a desired speed, to gradually change the applying width during an application work, to apply the applying liquid in a desired shape, etc. The motion control carried out by the control device 170 when applying the applying liquid to the application object W by the applying device 10 is described below in detail with reference to the flowchart of FIG. 7, along with an example where the applying liquid is applied in an application pattern shown in FIG. 8(a).

When applying in the application pattern shown in FIG. 8(a), the applying liquid is applied, while the adjustments (changes) of the discharge width D are made at the intermediate positions P1 and P2 provided between a start point S and an end point E. Specifically, in a section from the start point S to the intermediate position P1, the applying liquid is applied by the moving pump 50 and the variable discharge width device 100 by the position control, while adjusting the discharge width D to D1 and performing the feeding amount control. Then, when the application is completed up to the intermediate position P1, the discharge width D is then changed to D2, and the application progresses to the intermediate position P2 under the feeding amount control and the position control. When the application progresses up to the intermediate position P2, the discharge width D is then changed to D1, and the application progresses to the end point E under the feeding amount control and the position control.

Describing the series of operation described above according to the flowchart of FIG. 7, when applying the applying liquid to the application object W, first, in Step 1, the control device 170 moves the industrial robot 20 and the arm 22 based on the positional information indicative of the position where the application starts (start point S), and moves the variable discharge width device 100 attached to the tip end of the pump 50 to the position of the start point S. Then, when the control flow proceeds to Step 2, the control device 170 then adjusts the rotating amount and the rotating direction of the drive 152, and it rotates the inner cylindrical part 130 so that the discharge width D matches with the applying width. When applying in the application pattern of FIG. 8(a), the discharge width D is adjusted to D1 if the variable discharge width device 100 exists at the start point S. Then, when the application of the applying liquid progresses and it reaches the intermediate position P1 or the intermediate position P2, the discharge width D is adjusted to D2 or D1.

Here, if the adjustment of the discharge width D is made in Step 2, since the discharging amount of the applying liquid changes, it is also necessary to adjust the feeding amount of the applying liquid to the variable discharge width device 100. Specifically, since the discharging amount of the applying liquid increases when the discharge width D expands, it is necessary to increase the revolving speed of the rotor 72 in the pump 50 so that the feeding amount of the applying liquid to the variable discharge width device 100 increases. On the contrary, since the discharging amount of the applying liquid decreases when the discharge width D decreases, it is necessary to decrease the revolving speed of the rotor 72 and the discharging amount of the applying liquid. Thus, when the discharge width D is adjusted in Step 2, the feeding amount of the applying liquid to the variable discharge width device 100 is then adjusted under the feeding amount control in Step 3.

When the control flow proceeds to Step 4, the variable discharge width device 100 attached to the tip end of the pump 50 is moved according to the application pattern by moving the industrial robot 20 and the arm 22. Thus, the applying liquid is discharged with the discharge width D which is set in Step 2, and it is applied to the application object W.

After the movement of the variable discharge width device 100 is started in Step 4, if it is confirmed that the variable discharge width device 100 reaches a position at which the discharge width D is to be changed, specifically, the intermediate position P1 or the intermediate position P2, the control flow is then returned to Step 2. When the control flow returns to Step 2, the applying operation is performed after the discharge width D is changed according to the flow of Steps 2 to 4 described above.

On the other hand, when it is determined in Step 4 that the position of the variable discharge width device 100 is not at the discharge width changing positions (the intermediate positions P1 and P2), the control flow proceeds to Step 6. In Step 6, it is checked whether the variable discharge width device 100 has reached the end point E. If it is determined that the variable discharge width device 100 has not reached the end point E, it is in the middle of applying operation and, thus, the control flow returns to Step 4 to continue the applying operation. On the other hand, if it is determined in Step 6 that the variable discharge width device 100 has reached the end point E, the control flow then proceeds to Step 7 and the applying operation is changed to an idle state. Specifically, the movement of the variable discharge width device 100 or the like, and the feeding of the applying liquid by the pump 50 are suspended, and the discharge width D is changed to zero. Thus, the application of the applying liquid to the application object W is completed, and the series of control flow is completed.

As described above, the variable discharge width device 100 adopted to the applying device 10 of this embodiment can discharge the applying liquid from the communicating area 148 which is formed by intersecting the circumferential part opening 138 formed in the inner cylindrical part 130 and the discharge port 116 formed in the outer cylindrical part 112. In addition, since the opening width d of the circumferential part opening 138 continuously changes in the circumferential direction of the inner cylindrical part 130, the variable discharge width device 100 can adjust the discharge width D by rotating the inner cylindrical part 130. Therefore, according to the variable discharge width device 100, it is possible to adjust the discharge width D to a desired size only by adjusting the rotating amount of the inner cylindrical part 130 and, thus, problems including a reduction in the operating efficiency resulting from the change in the discharge width D can be resolved.

Note that, in this embodiment, although the configuration in which the circumferential part opening 138 is formed so that the opening width d continuously varies in the circumferential direction of the inner cylindrical part 130 is illustrated, the present invention is not limited to this and it may be formed so that the opening width d varies intermittently.

The variable discharge width device 100 changes the discharge width D by rotating the inner cylindrical part 130 and, thus, a change in the internal capacity associated with the change in the discharge width D is hardly caused. Therefore, it can suppress to the minimum that a variation in the discharge pressure is caused with the change in the discharge width D. In addition, in the applying device 10 of this embodiment, since the pump 50 is adopted as the applying liquid feeding device, the applying liquid can be supplied to the variable discharge width device 100 at a substantially constant feeding amount and a substantially constant feeding pressure. Therefore, even if the applying width (the discharge width D) is changed continuously or intermittently, variations in application characteristics, such as the thickness of the applying liquid applied to the application object W (film thickness) and adhesiveness of the applying liquid hardly occur and, thus, the applying device 10 can apply the applying liquid in constant quality.

The variable discharge width device 100 is sealed in a liquid-tight manner between the circumferential wall 136 of the inner cylindrical part 130 and the inner circumferential wall 128 of the outer cylindrical part 112, by the O-rings 144 and 146 provided at the positions on the base end 130a side and the connecting end 130b side with respect to the circumferential part opening 138. In the variable discharge width device 100, the introduction port 118 for introducing the applying liquid fed by the pump 50 is formed at the position where it faces the circumferential part opening 138 in the circumferential wall 136 of the outer cylindrical part 112. Further, the opening width d of the circumferential part opening 138 is smaller at any location thereof than the opening width s of the discharge port 116 formed in the outer cylindrical part 112. Thus, the applying liquid introduced into the inner cylinder interior space 142 from the circumferential part opening 138 can be substantially directly introduced into the inner cylindrical part 130, and the discharge liquid can be prevented from being bitten between the inner cylindrical part 130 and the outer cylindrical part 112. Therefore, according to the variable discharge width device 100, it can prevent that the discharge liquid is leaked from an unexpected location of the discharge port 116, and the applying liquid can be applied with stable quality.

Note that, in this embodiment, although the configuration in which the O-rings 144 and 146 are formed in the inner cylindrical part 130 is illustrated, the present invention is not limited to this and it may have a configuration in which sealing members, such as O-rings, are provided on the outer cylindrical part 112 side. Further, the variable discharge width device 100 is provided with the O-rings 144 and 146 in order to achieve the liquid-tightness between the inner cylindrical part 130 and the outer cylindrical parts 112, but, instead of the O-rings 144 and 146 or in addition to the O-rings 144 and 146, other sealing members, such as Variseal® and lip seals, may also be provided. In this embodiment, although the example in which the opening width d of the circumferential part opening 138 is formed smaller than the opening width s of the discharge port 116 formed in the outer cylindrical part 112 is shown, the opening widths d and s may be identical.

The applying device 10 of this embodiment can be implemented in a state where the position control, the speed control, the feeding amount control, and the discharge width control are synchronized. In the applying device 10, it is possible to adjust the size of the discharge width D of the applying liquid to be discharged for application, a changing speed of the discharge width D, and the feeding amount of the applying liquid from the pump 50 to the variable discharge width device 100 (feeding speed) so that they become in suitable states according to a spatial relationship between the variable discharge width device 100 and the application object W, and the moving speed of the variable discharge width device 100. Thus, for example, as shown in FIG. 8(a), it is possible to apply the applying liquid with different widths according to locations of the application object W.

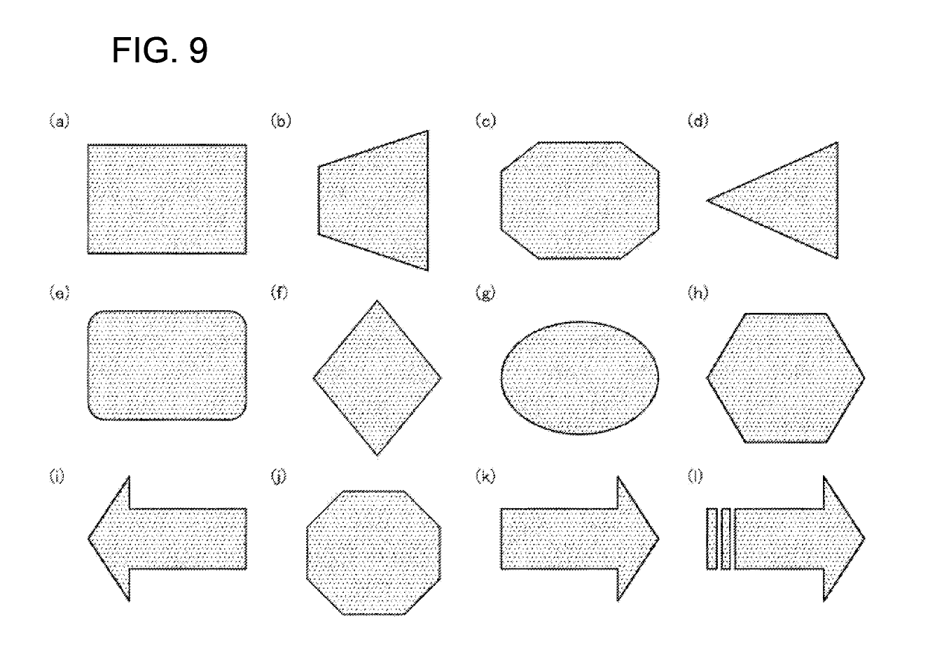

Note that, in this embodiment, the operation in the case where the applying liquid is applied in the application pattern shown in FIG. 8(a) is illustrated. However, the applying device 10 can apply the applying liquid to the application object W in various application patterns, such as the application patterns shown in FIGS. 8(b) to (d) and the application patterns (patterns) shown in FIGS. 9(a) to (l), other than the application pattern of FIG. 8(a), by adjusting the discharge width D and the like according to the position of the variable discharge width device 100, the moving speed, etc.

Although the discharge port 116 formed in the outer cylindrical part 112 of the variable discharge width device 100 of this embodiment is formed into the slit extending linearly in the width direction of the outer cylindrical part 112, the present invention is not limited to this. Specifically, it may have a configuration in which, instead of the discharge port 116, slits intermittently formed in the width direction of the outer cylindrical part 112, a slit formed so that it is inclined, a slit having a curved portion, an opening having its aperture shape of circle, ellipse, rectangle, or polygon, or the like may also be formed. By having this configuration, it is possible to discharge the applying liquid in more various forms, and to apply the applying liquid in the various application patterns.

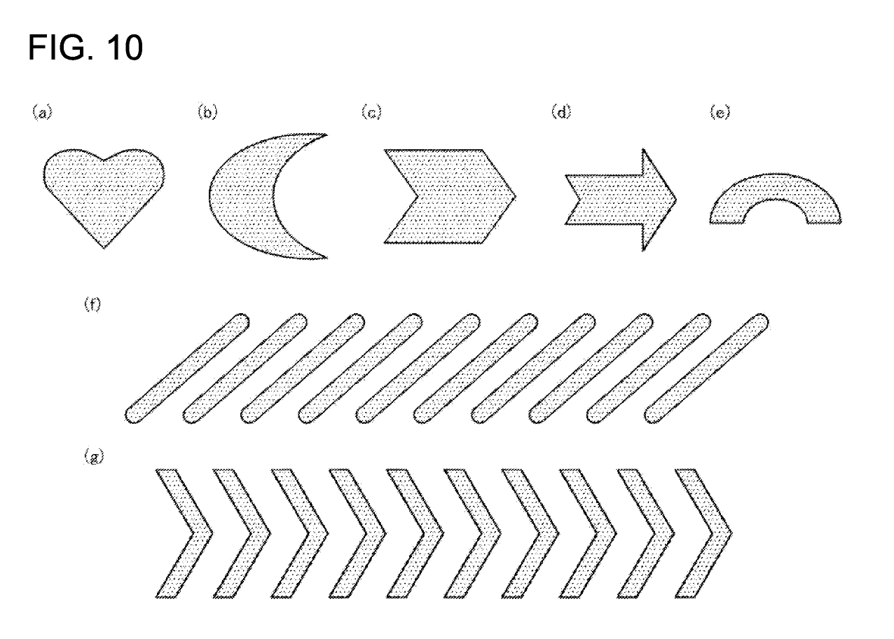

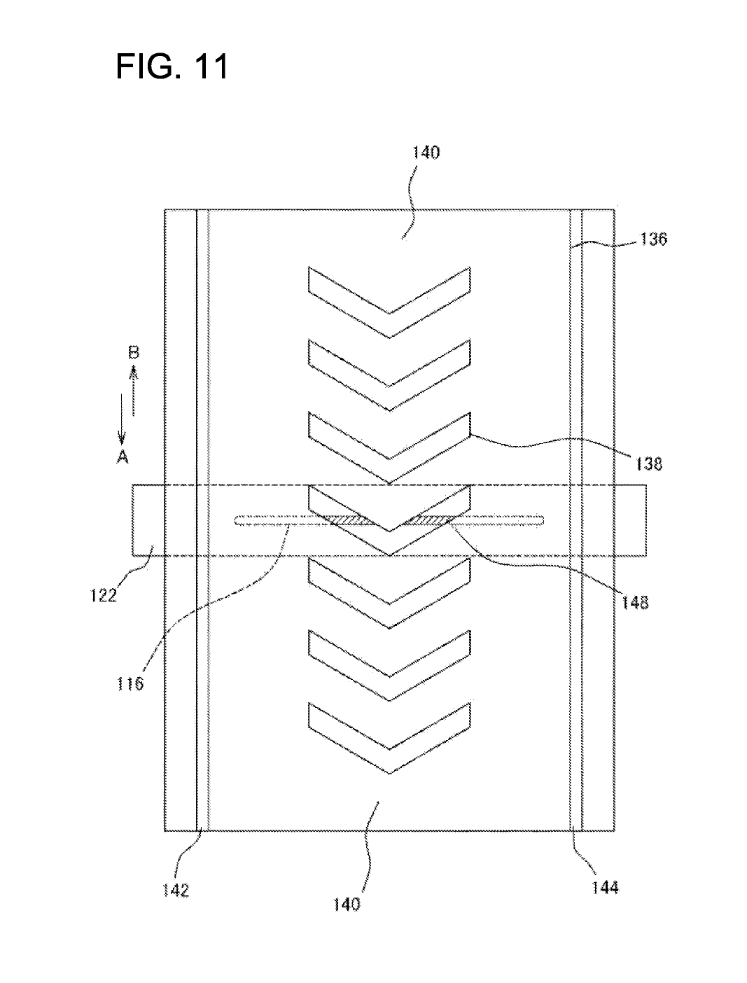

Further, in the variable discharge width device 100, the aperture shape of the circumferential part opening 138 formed in the inner cylindrical part 130 is also not limited to what is described above, similar to the discharge port 116, and it may be changed to various shapes according to the application patterns and the like. That is, the circumferential part opening 138 may have any aperture shape or size as long as it is formed so that the opening width D in the axial direction and the opening position in the axial direction may change in the circumferential direction of the inner cylindrical part 130. Specifically, if the shape of the circumferential part opening 138 is formed so that the application pattern becomes a desired shape in a state where the circumferential wall 136 of the inner cylindrical part 130 is developed, the applying liquid can be applied to the application object, for example, in the application patterns (patterns) like FIGS. 10(a) to (g), by synchronizing the movement of the variable discharge width device 100 and the rotation of the inner cylindrical part 130. More specifically, if the circumferential part opening 138 having the shape as shown in FIG. 11 is formed in the circumferential wall 136, the width and the position of the communicating area 148 is sequentially changed by rotating the inner cylindrical part 130 synchronized with the application speed and, thus, the applying liquid can be applied in the application pattern as shown in FIG. 10(g).

1. A variable discharge width device, comprising:
a hollow outer cylindrical part having a discharge port forming part where a discharge port is formed, inside and outside of the outer cylindrical part communicating with each other via the discharge port; and
a hollow inner cylindrical part, rotatable inside the outer cylindrical part along a circumferential wall of the outer cylindrical part,
wherein a circumferential part opening, formed in a circumferential wall of the inner cylindrical part so that an opening width thereof in an axial direction and/or an opening position thereof in the axial direction change in a circumferential direction of the inner cylindrical part, is formed so that inside and outside of the inner cylindrical part communicate with each other,
wherein fluid is able to be introduced into the inner cylindrical part, and
wherein the fluid introduced into the inner cylindrical part is able to be discharged from a communicating area formed by intersecting the circumferential part opening and the discharge port.

2. The variable discharge width device of claim 1, wherein a position of the inner cylindrical part on one end side and the other end side with respect to the circumferential part opening is formed in a liquid-tight manner between the circumferential wall of the inner cylindrical part and the circumferential wall of the outer cylindrical part.

3. The variable discharge width device of claim 1, wherein an introduction port for introducing the fluid fed from the outside is formed in the circumferential wall of the outer cylindrical part at a position where it faces the circumferential part opening.

4. The variable discharge width device of claim 1, wherein an opening width of the discharge port is greater than the opening width of the circumferential part opening in the axial direction.

5. The variable discharge width device of claim 1, comprising a control device capable of adjusting a rotating amount of the inner cylindrical part with respect to the outer cylindrical part according to a discharge width of the fluid.

6. A applying device, comprising:
a fluid feeding device for feeding fluid from the outside; and
a variable discharge width device for discharging the fluid fed by the fluid feeding device, with a predetermined discharge width,
wherein the fluid feeding device is comprised of a uniaxial eccentric screw pump, the variable discharge width device including:
a hollow outer cylindrical part having a discharge port forming part where a discharge port is formed, inside and outside of the outer cylindrical part communicating with each other via the discharge port; and
an inner cylindrical part, rotatable inside the outer cylindrical part along a circumferential wall of the outer cylindrical part,
wherein fluid is able to be introduced into the inner cylindrical part,
wherein a circumferential part opening, formed in a circumferential wall of the inner cylindrical part so that an opening width thereof in an axial direction and/or an opening position thereof in the axial direction change in a circumferential direction of the inner cylindrical part, is formed so that inside and outside of the inner cylindrical part communicate with each other, and
wherein the fluid introduced into the inner cylindrical part is able to be discharged from a communicating area formed by intersecting the circumferential part opening and the discharge port.

7. The applying device of claim 6, further comprising a control device implementable in a state where a discharge width control in which a discharge width of the fluid is controlled by adjusting a rotating amount of the inner cylindrical part with respect to the outer cylindrical part, and a feeding amount control in which a feeding amount of the fluid to the variable discharge width device is controlled by controlling operation of the uniaxial eccentric screw pump are synchronized.

8. The applying device of claim 7, further comprising:
a moving device capable of changing a relative position between an object to be applied and the fluid feeding device, wherein a position control in which a relative position of the fluid feeding device with respect to the object to be applied is controlled by a motion control of the moving device are synchronized.
